(19) United States
(12) Patent Application Publication
(10) Pub. No.: US 2026/0139961 A1
(43) Pub. Date: May 21, 2026

(54) MAP INFORMATION CREATION DEVICE AND MAP INFORMATION CREATION METHOD

(71) Applicant: HONDA MOTOR CO., LTD., Tokyo (JP)

(72) Inventors: Kazune FURUDO, Tokyo (JP); Masato OKUBO, Tokyo (JP)

(21) Appl. No.: 19/119,414

(22) PCT Filed: Sep. 28, 2023
(86) PCT No.: PCT/JP2023/035392

§ 371 Date: Apr. 9, 2025

(30) Foreign Application Priority Data
Oct. 13, 2022 (JP) 2022-164970

(51) Int. Cl. G01C 21/00

(52) U.S. Cl. CPC G01C 21/3807; G01C 21/3841; G01C 21/3867

(57) ABSTRACT

A map information generation device 1 comprises: a parking tendency information calculation unit 113 that calculates parking tendency information for the parking area polygon information; a parking area extraction unit 112 that extracts parking area polygon information for which the distance from the center position of one facility is within a prescribed distance; and a parking area determination unit 114 that, if a plurality of pieces of parking area polygon information were extracted by the parking area extraction unit 112, determines a piece of parking area polygon information from among the extracted pieces of parking area polygon information, on the basis of each piece of parking tendency information for the plurality of extracted pieces of parking area polygon information, the pieces of parking tendency information being calculated by the parking tendency information calculation unit 113.

### TECHNICAL FIELD

The present invention relates to a map information creation device and a map information creation method for easily linking parking lot polygons included in map information and facility information.

### BACKGROUND ART

A use of receiving, with a server, FCD (Floating Car Data) including GPS position information from a plurality of vehicles and utilizing, based on accumulated position information and the like, the FCD for data analysis concerning facilities that the vehicles visited has been spreading. In order to correctly grasp, based on position information of a vehicle, that a vehicle user stopped at, for example, a facility annexed with a parking lot, section information of the parking lot and the parking lot being a parking lot of the relevant facility need to be correctly registered on a map. Parking sections are registered in a map layer in a polygon format. This polygon information can also be registered by requesting an external company to register the polygon information. In an existing OSM (Open Street Map), there are also parking lot polygons already registered. However, it is often unknown whether the respective parking lot polygons are parking lots for facility users annexed to the facility or are parking lots for individuals such as monthly parking lots. Further, in the case of a parking lot annexed to a facility, it is often unknown to which facility the parking lot belongs because facility information and a parking lot grid are not linked. For example, WO2019-065328 discloses a technique of dividing map information into a plurality of mesh regions, setting, in the mesh regions, a region where vehicles have been parked a plurality of times as a determination target region and determining, as a home parking lot, the mesh region where a specific vehicle has been parked, and determining, as parking lots of a facility, the mesh regions where unspecified large number of vehicles have been parked. However, the technique described in WO2019-065328 discloses that a facility close to latitude and longitude indicating a region of the parking lot determined as the parking lot of the facility is associated with the parking lot. However, when a plurality of facilities are present, parking lot attributes are merely given. The facilities are not specified. Japanese Unexamined Patent Application, Publication No. 2020-144587 describes that continuous position information from a plurality of vehicles is received together with hour information, when there is no change in the position information for a predetermined time or more, it is determined that a vehicle has been parked, a parking position information table in which the position information is set as a parking position of the vehicle and a parking time including date and time information is recorded together with the parking position is created, and, for each of a plurality of facilities, a standard parking time corresponding to a type of the facility and the parking time of the vehicle are compared to determine, as a facility where the vehicle has stayed, a facility corresponding to the facility type where the vehicle is likely to have stayed among the plurality of facilities.

### CITATION LIST

### Patent Document

Patent Document 1: WO 2019-065328

Patent Document 2: Japanese Unexamined Patent Application, Publication No. 2020-144587

### DISCLOSURE OF THE INVENTION

### Problems to be Solved by the Invention

In order to enable an analysis of visitors to a facility with, for example, a big data analysis of FCD acquired from vehicles, there have been demands for a map information creation device and a map information creation method that can easily link a parking lot polygon included in map information and facility information.

The present invention has been made in view of such a problem, and an object of the present invention is to provide a map information creation device and a map information creation method for, when a plurality of pieces of parking lot polygon information are present around a facility, determining, out of the plurality of pieces of parking lot polygon information, parking lot polygon information included in a parking lot of the facility without relying on human labor.

### Means for Solving the Problems

(1) A map information creation device (for example, a map information creation device 1 explained below) of the present invention includes:
a map information storage (for example, a map information storage unit 122 explained below) that stores map information including center position information of a facility as facility information for a plurality of facilities and a plurality of pieces of parking lot polygon information;
a vehicle parking position information table (for example, a vehicle parking position information table 124 explained below) including at least parking position information, date and time information of parking, and a parking time collected within a predetermined period, the parking position information being position information of a vehicle in a case in which there is no change in position information of the vehicle for a predetermined time or more;
a parking tendency information calculator (for example, a parking tendency information calculation unit 113 explained below) that calculates parking tendency information of the parking lot polygon information with reference to the vehicle parking position information table;
a parking lot extractor (for example, a parking lot extraction unit 112) that extracts the parking lot polygon information, a distance of which from a center position of one facility of the facility information is within a predetermined distance; and
a parking lot determiner (for example, a parking lot determination unit 114) that determines, when a plurality of pieces of the parking lot polygon information have been extracted by the parking lot extractor, based on parking tendency information of the plurality of pieces of parking lot polygon information extracted, the parking tendency information being calculated by the parking tendency information calculator, out of the plurality of pieces of parking lot polygon information extracted, the parking lot polygon information included in the parking lot of the facility.

With above (1), when a plurality of pieces of parking lot polygon information are present around a facility, it is possible to determine, out of the plurality of pieces of parking lot polygon information, the parking lot polygon information included in a parking lot of the facility without relying on human labor.

(2) The map information creation device (for example, the map information creation device 1 explained below) described in above (1) may further include:
a receiver (for example, a receiving unit 110A explained below) that receives continuous position information from a plurality of vehicles together with hour information; and
a parking position information recorder (for example, a parking position information recording unit 110B explained below) that determines that a vehicle has parked when there is no change in the position information for a predetermined time or more and stores, in a storage, as a vehicle parking position information table, parking position information where the vehicle is determined as being parked.

With above (2), the same effects as the effects of the map information creation device in above (1) are achieved.

(3) In the map information creation device (for example, the map information creation device 1 explained below) described in above (1),
size information indicating a size of the facility may be provided as the facility information,
the map information creation device may further include a parking lot area information table (for example, a parking lot area information table 123 explained below) representing a correspondence relation between an area serving as a size of the facility or a range of the area and a parking lot area of the facility standardly assumed according to the size of the facility or a range of the parking lot area, and the parking lot determiner (for example, the parking lot determination unit 114 explained below) may further, even when a plurality of pieces of the parking lot polygon information have been extracted by the parking lot extractor (for example, the parking lot extraction unit 112 explained below), when the size information of the facility is equal to or smaller than a size associated with an area obtained by totaling areas of the parking lot polygon information determined as being included in the parking lot of the facility, not determine that the plurality of pieces of parking lot polygon information extracted as the parking lot polygon information are included in the parking lot of the facility.

With above (3), it is possible to prevent wrong determination of a parking lot not matching a facility size.

(4) In the map information creation device (for example, the map information creation device 1 explained below) described in above (1) to (3),
the parking tendency information calculator (the for example, the parking tendency information calculation unit 113 explained below) may plot, in the parking lot polygon, the parking position information included in the vehicle parking position information table (the vehicle parking position information table 124 explained below), the parking position information being located in the parking lot polygon, and calculate the tendency information of the parking lot polygon information based on the plotted parking position information.

With above (4), even when a large number of pieces of parking lot polygon information are present around a facility, it is possible to determine a parking lot of the facility without relying on human labor.

(5) In the map information creation device (for example, the map information creation device 1 explained below) described in above (4), the parking tendency information of the parking lot polygon information may include at least any one of statistical values based on parking lot entering hours of vehicles parked in the parking lot in a predetermined period and statistical values based on staying times of the vehicles.

With above (5), when, for example, business hour periods, visiting hours of visitors, staying times, or the like in parking lots are similar, it is possible to determine, without relying on human labor, the parking lots as parking lots of the same facility.

(6) A map information creation method in the present invention is a map information creation method executed by a computer, the map information creation method including:
a map information storing step of storing map information including center position information of a facility as facility information for a plurality of facilities and a plurality of pieces of parking lot polygon information;
a step of storing a vehicle parking position information table (for example, a vehicle parking position information table 124 explained below) including at least parking position information, date and time information of parking, and a parking time collected within a predetermined period, the parking position information being position information of a vehicle in a case in which there is no change in position information of the vehicle for a predetermined time or more;
a parking tendency information calculating step of calculating parking tendency information of the parking lot polygon information with reference to the vehicle parking position information table;
a parking lot extracting step of extracting the parking lot polygon information, a distance of which from a center position of one facility of the facility information is within a predetermined distance; and
a parking lot determining step of determining, when a plurality of pieces of the parking lot polygon information have been extracted in the parking lot extracting step, based on parking tendency information of the plurality of pieces of parking lot polygon information extracted, the parking tendency information being calculated by the parking tendency information calculating step, out of the plurality of pieces of parking lot polygon information extracted, the parking lot polygon information included in the parking lot of the facility.

With the method in above (6), the same effects as the effects of the map information creation device in above (1) are achieved.

### Effects of the Invention

According to the present invention, it is possible to provide a map information creation device and a map information creation method for, when a plurality of pieces of parking lot polygon information are present around a facility, determining, out of the plurality of pieces of parking lot polygon information, parking lot polygon information included in a parking lot of the facility without relying on human labor.

### BRIEF DESCRIPTION OF THE DRAWINGS

FIG. 1 is a block diagram illustrating a basic configuration of a map information creation device in an embodiment of the present invention;

FIG. 2 is a diagram illustrating an example of a vehicle parking position information table in the embodiment of the present invention;

FIG. 3 is a diagram illustrating a distance between a facility and a parking lot polygon in the embodiment of the present invention;

FIG. 4 is a diagram illustrating an example of parking tendency information of a parking lot in the embodiment of the present invention;

FIG. 5 is a flowchart illustrating an operation of determining that a plurality of parking lot polygons are parking lots of one facility and creating a map in the embodiment of the present invention;

FIG. 6 is a flowchart illustrating an operation of calculating, for a designated parking lot polygon, parking tendency information (also referred to as “parking pattern”) in the parking lot in the embodiment of the present invention;

FIG. 7 is a block diagram illustrating a basic configuration according to a modification of the map information creation device in the embodiment of the present invention; and

FIG. 8 is a diagram illustrating an overview of a data structure of a position information database according to the modification of the map information creation device in the embodiment of the present invention.

### PREFERRED MODE FOR CARRYING OUT THE INVENTION

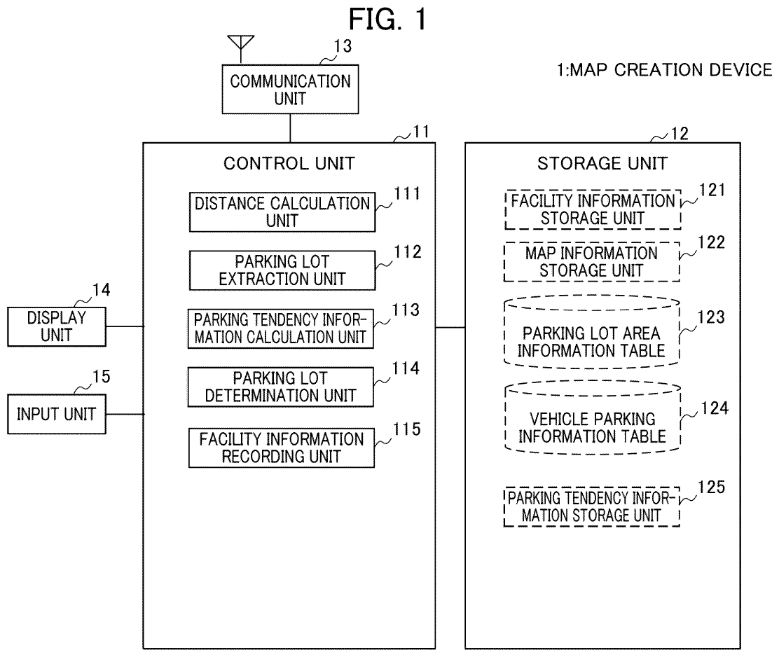

A preferred embodiment of a map information creation device of the present invention is explained in detail below with reference to the figures. A basic configuration of a map information creation device 1 is illustrated in FIG. 1. Functional blocks included in the map information creation device 1 are explained with reference to a block diagram of FIG. 1.

As illustrated in FIG. 1, the map information creation device 1 includes a control unit 11, a storage unit 12, a communication unit 13, a display unit 14, and an input unit 15.

The control unit 11 is configured from an arithmetic processing device such as a microprocessor and controls the units configuring the map information creation device 1. Details of the control unit 11 are explained below.

The storage unit 12 is configured by a semiconductor memory or the like and stores programs such as a program for control called firmware or operating system and a program for performing map information creation processing and further stores various kinds of information such as map information. In the figure, as the information stored by the storage unit 12, a facility information storage unit 121 that stores respective facility information for a plurality of facilities, a map information storage unit 122 that stores map information including center position information of the facilities and polygon information of parking lots, a facility parking lot area information table 123, and a vehicle parking position information table 124 are illustrated. Note that, in the embodiment explained below, it is assumed that a coin-operated parking and the like that are not a parking lot of a facility are excluded from a determination target of the present invention in advance. The coin-operated parking and the like are described on a map and can be excluded from the determination target. A parking lot for individuals such as a monthly parking lot can be easily determined based on characteristics; for example, a parking time of parking in the parking lot is long, a parking time at night is particularly long, and the number of vehicles parked at night and the number of parked vehicles calculated from the area of the parking lot are in a close relation. Therefore, the parking lot for individuals can be excluded as a parking lot not included in the determination target of the present invention. The facility information includes, for example, an identification information (a facility ID) of a facility, a name of the facility, a facility type (and/or a genre) concerning a type of the facility, a telephone number, an address, a business hour, center position information indicating a center position (for example, information of latitude and longitude) of the facility, and a size of the facility (for example, a site area of the facility or a total floor area obtained by totaling floor areas of the facility). Here, the facility type indicates a business category of the facility such as a convenience store, a hospital, or a car dealer. The parking lot area information table 123 of the facility indicates a table representing a correspondence relation between an area serving as a size of the facility or a range of the area and a parking lot area of the facility standardly assumed according to the size of the facility or a range of the parking lot area. Note that, for example, a range of the size may be set as the size of the facility in the parking lot area information table 123 and, on the other hand, for example, a range of the area of the parking lot may be associated as the parking lot area of the facility.

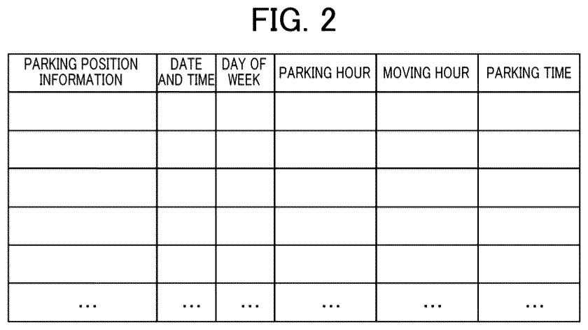

The vehicle parking position information table 124 indicates a table storing vehicle parking information including at least parking position information, date and time information of parking, and a parking time collected in a predetermined region (for example, a prefecture or a municipality) and in a predetermined period (for example, one year). Here, it is assumed that the parking position information is position information of a vehicle in the case in which there is no change in the position information of the vehicle for a predetermined time or more. FIG. 2 is a diagram illustrating an overview of the vehicle parking position information table 124. Note that the vehicle parking position information table 124 is created based on a position information database (not illustrated) including movement transition information created using FCD (Floating Car Data) including a vehicle ID, position information, and hour information received from, for example, a connected car. The creation of the vehicle parking position information table is the publicly-known technique for those skilled in the art as described in, for example, Japanese Unexamined Patent Application, Publication No. 2020-144587. Note that the vehicle ID can be prevented from being included in the vehicle parking position information table 124 from the viewpoint of personal information protection. In the present embodiment, the vehicle parking position information table 124 is configured to be downloaded as appropriate from a server device (not illustrated) connected to a communication network 60.

Note that the facility information, the map information, the parking lot area information table 123, the vehicle parking position information table 124, and the like may be configured to be stored in the storage unit 12 in advance or may be configured to be downloaded as appropriate from the server device (not illustrated) connected to the communication network 60. Further, these pieces of information may be corrected as appropriate according to, for example, input of a user. In the present embodiment, the vehicle parking position information table 124 is configured to be downloaded as appropriate from a server device (not illustrated) connected to a communication network 60.

The communication unit 13 includes a DSP or the like and conforms to a standard such as LTE (Long Term Evolution), 4G (4th Generation), or 5G (5 th Generation) or a standard such as Wi-Fi (registered trademark) and implements wireless communication or wired communication with another device (for example, the server explained above) via the communication network 60. Note that the communication network 60 is implemented by a network such as the Internet or a cellular phone network or a network obtained by combining the Internet and the cellular phone network. A LAN (Local Area Network) may be included in a part of the network.

The display unit 14 is configured by a display device such as a liquid crystal display or an organic electroluminescence panel. The display unit 14 receives an instruction from the control unit 11 and displays an image. The input unit 15 is configured by an input device (not illustrated) or the like such as a physical switch called ten-key pad or a touch panel provided to be laid over a display surface of the display unit 14.

Subsequently, details of the control unit 11 are explained. The control unit 11 is configured by a microprocessor including a CPU, a RAM, a ROM, and an I/O. The CPU executes programs read from the ROM or the storage unit 12 and, in the execution of the programs, reads information from the RAM, the ROM, and the storage unit 12, writes information in the RAM and the storage unit 12, and exchanges signals with the communication unit 13. In this way, hardware and software (programs) cooperate, whereby processing in the present embodiment is implemented.

The control unit 11 includes, as functional blocks, a distance calculation unit 111, a parking lot extraction unit 112, a parking tendency information calculation unit 113, a parking lot determination unit 114, and a facility information recording unit 115.

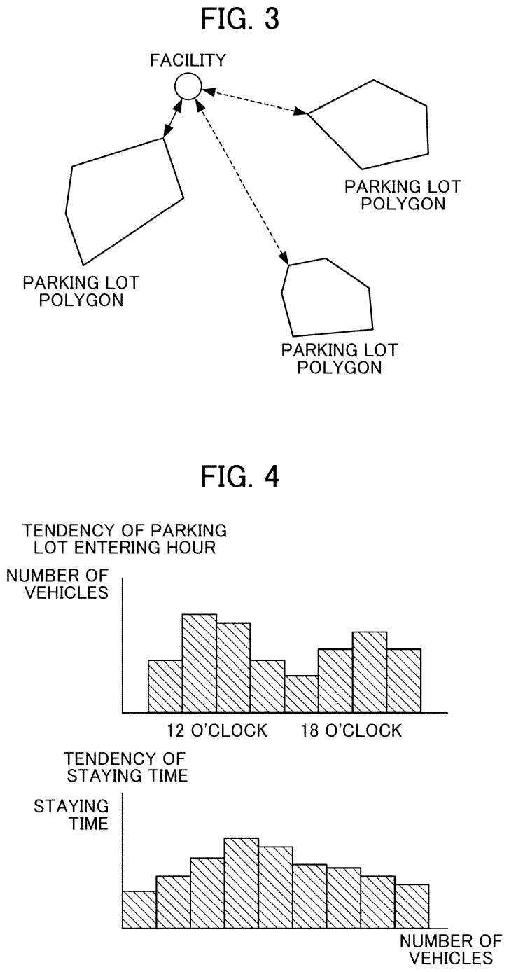

The distance calculation unit 111 calculates a distance between center position information of a facility included in facility information and one node of parking lot polygon information. Here, the one node of the parking lot polygon information means a position included in a parking lot polygon and present at the shortest distance from the center position information of the facility. FIG. 3 is a diagram illustrating a distance between a facility and a parking lot polygon. As illustrated in FIG. 3, the distance between the facility and the parking lot polygon is the shortest distance among distances between the center position of the facility and any positions included in the parking lot polygon. Note that, when the center position of the facility is included in the parking lot polygon, the distance between the center position information of the facility included in the facility information and the one node of the parking lot polygon information is 0 (zero).

The parking lot extraction unit 112 extracts, for a parking lot having parking lot polygon information, parking lot polygon information in which the distance from a center position of one facility selected by a user to a parking lot polygon is equal to or shorter than a predetermined distance.

The parking tendency information calculation unit 113 calculates, for a designated parking lot polygon, parking tendency information (also referred to as “parking pattern”) in the parking lot. Here, examples of the parking tendency information (the parking pattern) include a tendency of parking lot entering hours of vehicles parked in the parking lot and a tendency of staying times (parking times) of the vehicles parked in the parking lot. As the parking tendency information (the parking pattern), a tendency of parking lot entering hours of vehicles or a tendency of staying times (parking times) of the vehicles may be further shown for each day of week. FIG. 4 is a diagram illustrating an example of parking tendency information of a parking lot. Here, as an example, a tendency of parking lot entering hours and a tendency of staying times are illustrated. The horizontal axis of a graph indicating the parking lot entering hour tendency indicates an hour range (for example, 9:00 to 10:00, 10:00 to 11:00, or the like) and the vertical axis indicates an average number, a number ratio, or the like of vehicles parked in every hour range of a predetermined period (or each day of week). A graph indicating the staying time tendency indicates which degree of the number (or the number ratio) of vehicles stayed for which degree of time, for example, in a predetermined period (or each day of week). Specifically, for example, the vertical axis may indicate the staying time and the horizonal axis may indicate the average number, the number ratio, or the like of vehicles stayed for the staying time. For example, when a facility has two or more parking lots (referred to as parking lot A, parking lot B, and the like) around the facility, it can be predicted that pieces of parking tendency information (parking patterns) of the parking lot A and the parking lot B are similar. Then, as explained below, when a plurality of parking lots, the distances of which from the facility are equal to or shorter than a predetermined distance, are present, it is predicted that all parking lots, pieces of parking tendency information (parking patterns) of which are similar, are parking lots of the facility. A method of calculating parking tendency information (also referred to as “parking pattern”) by the parking tendency information calculation unit 113 is explained below. The parking tendency information calculation unit 113 refers to the vehicle parking position information table 124 and collects vehicle parking information in which a parking position is included in the parking lot in a predetermined period. The parking tendency information calculation unit 113 can calculate, based on date and time information (a date, a day of week, a parking lot entering hour, and the like) when a vehicle was parked in the parking lot and a parking time included in the vehicle parking information, for example, a tendency of a parking lot entering hour of the vehicle or a tendency of a staying time (a parking time) of the vehicle in the parking lot. If necessary, the parking tendency information calculation unit 113 can calculate a tendency of a parking lot entering hour of the vehicle or a tendency of a staying time (a parking time) of the vehicle for each day of week. Note that, when calculating the parking tendency information of the parking lot, the parking tendency information calculation unit 113 may store the calculated parking tendency information in the storage unit 12 in association with parking lot identification information (a parking lot polygon ID).

When facility information (for example, a facility ID) is included in parking lot polygon information, the parking lot determination unit 114 determines the parking lot polygon information as a parking lot of a facility identified by the facility ID. When center position information of a facility included in the facility information is included in the parking lot polygon information, the parking lot determination unit 114 determines the parking lot polygon information as a parking lot of the facility. As explained above, when a plurality of pieces of parking lot polygon information are present around one facility, the parking lot determination unit 114 is capable of determining parking lot polygon information included in a parking lot of the facility out of the plurality of pieces of parking lot polygon information without relying on human labor.

When a plurality of pieces of parking lot polygon information, in which the distances from a center position of one facility to a parking lot polygon is equal to or shorter than a predetermined distance, have been extracted by the parking lot extraction unit 112, the parking lot determination unit 114 may determine, based on parking tendency information of the extracted plurality of pieces of parking lot polygon information calculated by the parking tendency information calculation unit 113, a set of parking lot polygons having similar parking tendency information out of the extracted plurality of pieces of parking lot polygon information as the parking lot of the facility. However, the parking lot determination unit 114 may refer to the parking lot area information table 123 and compare size information of the facility and a set area of the parking lot polygon determined as the parking lot of the facility. Specifically, when the size information of the facility is smaller than a size associated with an area obtained by totaling areas of parking lot polygons included in a set of parking lot polygons determined as parking lots of the facility, the parking lot determination unit 114 can prevent a set of the extracted plurality of pieces of parking lot polygon information from being determined as parking lots of the facility. Accordingly, it is possible to prevent erroneous determination of determining a parking lot not matching a facility size as a parking lot of the facility. Note that, in the present embodiment, in order to accurately perform an analysis that a vehicle is a user of the facility, importance is placed on not determining the parking lot as a parking lot of the facility when an area obtained by totaling areas of a plurality of parking lots is excessive with respect to the facility size. That is, it can be determined that, when a parking lot having an area equal to or larger than the facility size is prepared, a state of holding an unused area is usually unconceivable. Conversely, it is conceivable that a parking lot area corresponding to the facility size cannot always be ensured because of a site condition and the like. Therefore, when a parking lot area is small with respect to the facility size, it is determined appropriate not to reject the parking lot area. However, as explained above, it is possible to give certain degrees of ranges respectively for an area of a parking lot with respect to a facility size and a facility size with respect to the area of the parking lot by forming the parking lot area information table 123 as a table representing a correspondence relation between an area serving as a size of a facility or a range of the area and a parking lot area of the facility standardly assumed according to the size of the facility or a range of the parking lot area. According to the setting of the range, the range in the case in which the parking lot area is small with respect to the facility size may be increased and, conversely, the range in the case in which the parking lot area is large with respect to the facility size may be reduced.

The facility information recording unit 115 stores the facility information determined by the parking lot determination unit 114 in the map information storage unit 122 in association with parking lot polygon information. Accordingly, it is possible to create a map in which parking lot polygons included in map information and facility information are easily linked without manually linking the facility information with the parking lot polygons included in the map information. The configurations of the functional units of the map information creation device 1 exemplified as the present embodiment are explained above.

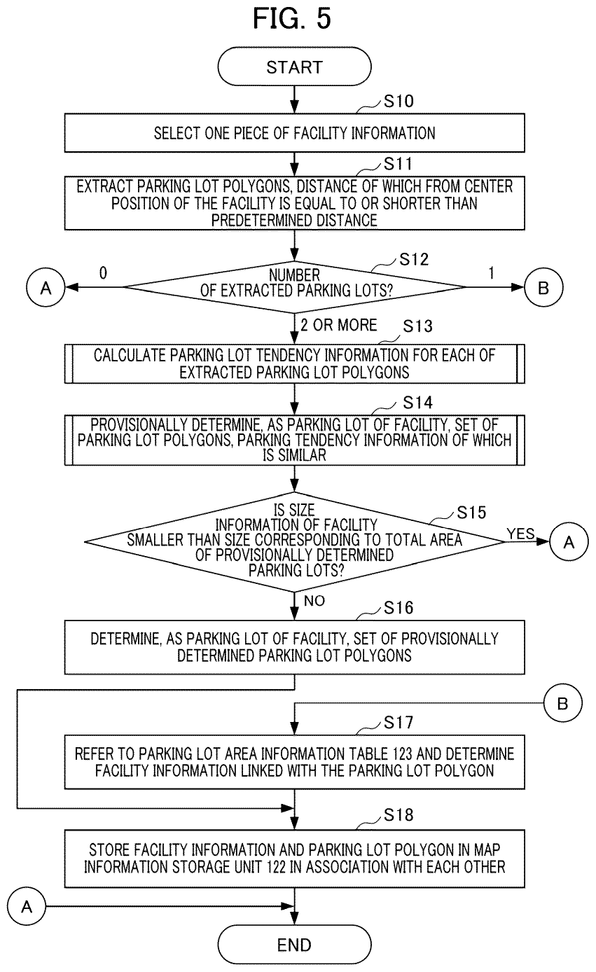

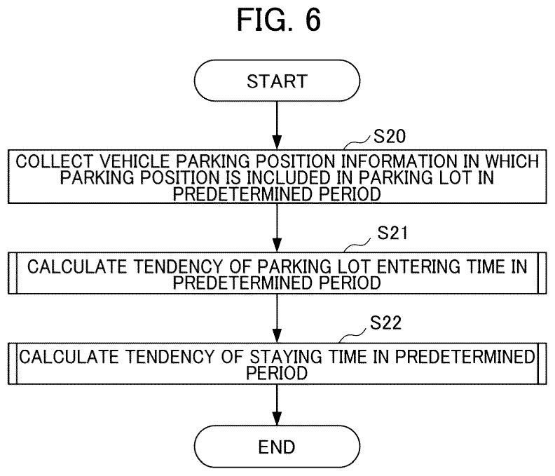

Subsequently, an operation in the present embodiment is explained with reference to flowcharts described in FIG. 5 and FIG. 6. Here, FIG. 5 is a flowchart illustrating an operation of determining that a plurality of parking lot polygons are parking lots of one facility and creating a map. FIG. 6 is a flowchart illustrating an operation of calculating, for a designated parking lot polygon, parking tendency information (also referred to as “parking pattern”) in the parking lot. Note that, as explained above, parking lots for individuals such as a coin-operated parking and a monthly parking lot that are not parking lots of a facility have been excluded as parking lots not included in a determination target of the present invention. When tag information indicating a facility is present in a parking lot polygon and when the parking lot polygon includes center position information of the facility, it is assumed that the facility information is stored in the map information storage unit 122 in linkage with the parking lot polygon. For this reason, in a processing flow described below, such a parking lot polygon is not included in a target.

Referring to FIG. 5, in step S10, the map information creation device 1 (the parking lot determination unit 114) selects one piece of facility information.

In step S11, the map information creation device 1 (the parking lot extraction unit 112) extracts parking lot polygon information in which the distance from the center position of a facility to a parking lot polygon is equal to or shorter than a predetermined distance.

In step S12, when the extracted parking lot polygon information is one piece of information, the map information creation device 1 (the parking lot determination unit 114) shifts to step S17. When a plurality of pieces of parking lot polygon information have been extracted, the map information creation device 1 (the parking lot determination unit 114) shifts to step S13. Note that, when no parking lot polygon information has been extracted, the map information creation device 1 (the parking lot determination unit 114) ends the processing.

In step S13, the map information creation device 1 (the parking tendency information calculation unit 113) calculates parking tendency information for each of extracted parking lot polygons.

In step S14, the map information creation device 1 (the parking lot determination unit 114) provisionally determines, from the extracted parking lot polygons, a set of parking lot polygons, pieces of parking tendency information of which are similar, as parking lots of the facility.

In step S15, the map information creation device 1 (the parking lot determination unit 114) refers to the parking lot area information table 123 and, when size information of the facility is smaller than a size associated with an area obtained by totaling the areas of the parking lot polygons included in the set of the parking lot polygons determined as the parking lots of the facility. Otherwise, the map information creation device 1 (the parking lot determination unit 114) shifts to step S16.

In step S16, the map information creation device 1 (the parking lot determination unit 114) determines the set of the parking lot polygons, pieces of parking tendency information of which are similar, as parking lots of the facility, links the facility information with the set of the parking lot polygons, and shifts to step S18.

When determining in step S17 that the extracted parking lot polygon is a parking lot of the facility, the map information creation device 1 (the parking lot determination unit 114) links the parking lot polygons with the facility and shifts to step S18. Otherwise, the map information creation device 1 (the parking lot determination unit 114) ends the processing.

In step S18, the map information creation device 1 (the facility information recording unit 115) stores the facility information and the parking lot polygon information in the map information storage unit 122 in association with each other. In particular, when a plurality of parking lot polygons are associated with one piece of facility information, the parking lot polygon is stored as one of distributed parking lots of the facility.

The processing in step S17 is supplementarily explained. First, when facility information (for example, a facility ID) is tagged to the parking lot polygon information, the map information creation device 1 (the parking lot determination unit 114) determines the parking lot polygon information as a parking lot of a facility identified by the facility ID. Subsequently, when center position information of a facility included in the facility information is included in the parking lot polygon information, the map information creation device 1 (the parking lot determination unit 114) determines the parking lot polygon information as a parking lot of the facility. The map information creation device 1 (the parking lot determination unit 114) refers to the parking lot area information table and, when the facility has size information close to size information of the facility associated with an area of a parking lot calculated from the parking lot polygon information, determines the parking lot polygon information as a parking lot of the facility. Otherwise, the map information creation device 1 (the parking lot determination unit 114) determines that the parking lot polygon information is not a parking lot of the facility.

Accordingly, when a plurality of pieces of parking lot polygon information are present around one facility, the map information creation device 1 is capable of determining a set of parking lots of the facility out of the plurality of pieces of parking lot polygon information without relying on human labor.

Subsequently, an operation of calculating, for a parking lot polygon designated with reference to the flowchart described in FIG. 6, parking tendency information (a parking pattern) in the parking lot.

Referring to FIG. 6, in step $20, the map information creation device 1 (the parking tendency information calculation unit 113) refers to the vehicle parking position information table 124 and collects vehicle parking information in which a parking position is included in the parking lot in a predetermined period.

In step S21, the map information creation device 1 (the parking tendency information calculation unit 113) calculates, based on the collected vehicle parking information, for example, an average number, a number ratio, or the like (a tendency of parking lot entering hours) of parking vehicles in each hour range of a predetermined period (or each day of week).

In step S22, the map information creation device 1 (the parking tendency information calculation unit 113) calculates, based on the collected vehicle parking information, for example, an average number, a number ratio, or the like (a tendency of staying times) of parking vehicles in each range of a staying time in a predetermined period (or each day of week). Accordingly, it is possible to calculate, for the parking lot polygon, parking tendency information (a parking pattern) in the parking lot.

The operation of the map information creation device 1 for, when a plurality pieces of parking lot polygon information are present around a facility, determining, out of the plurality of pieces of polygon information, parking lot polygon information included in a parking lot of the facility is explained above. In the explanation, the operation of the map information creation device 1 for calculating parking tendency information of a parking lot polygon and determining, as a parking lot of the facility, a parking lot polygon similar to the parking tendency information is explained. Accordingly, when a plurality of pieces of parking lot polygon information are present around a facility, the map information creation device 1 is capable of determining, out of the plurality of parking lot polygon information, parking lot polygon information included in a parking lot of the facility without relying on human labor.

According to the present embodiment explained above, when a plurality of pieces of parking lot polygon information are present around one facility, it is possible to determine, out of the plurality of pieces of parking lot polygon information, parking lot polygon information included in a parking lot of the facility without relying on human labor.

Each of the devices can be implemented by hardware, software, or a combination of the hardware and the software. A navigation method performed by the devices included in the navigation system explained above cooperating with one another can also be implemented by hardware, software, or a combination of the hardware and the software. Here, the navigation method being implemented by software means the navigation method being implemented by a computer reading and executing a program.

The program can be stored using non-transitory computer-readable media of various types and supplied to a computer. The non-transitory computer-readable media include tangible storage media of various types. Examples of the non-transitory computer-readable media include a magnetic recording medium (for example, a flexible disk, a magnetic tape, and a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EPROM (Erasable PROM), a flash ROM, and a RAM (random access memory) ). The program may be supplied to the computer by transitory computer readable media of various types. An example of the transitory computer readable media include an electric signal, an optical signal, and an electromagnetic wave. The transitory computer-readable media can supply the program to the computer via a wired communication line such as an electric wire and an optical fiber or a wireless communication line.

The embodiment explained above is a preferred embodiment of the present invention. However, the scope of the present invention is not limited to only the embodiment. Implementation in forms applied with various changes in a range not departing from the gist of the present invention is possible.

### Modification 1

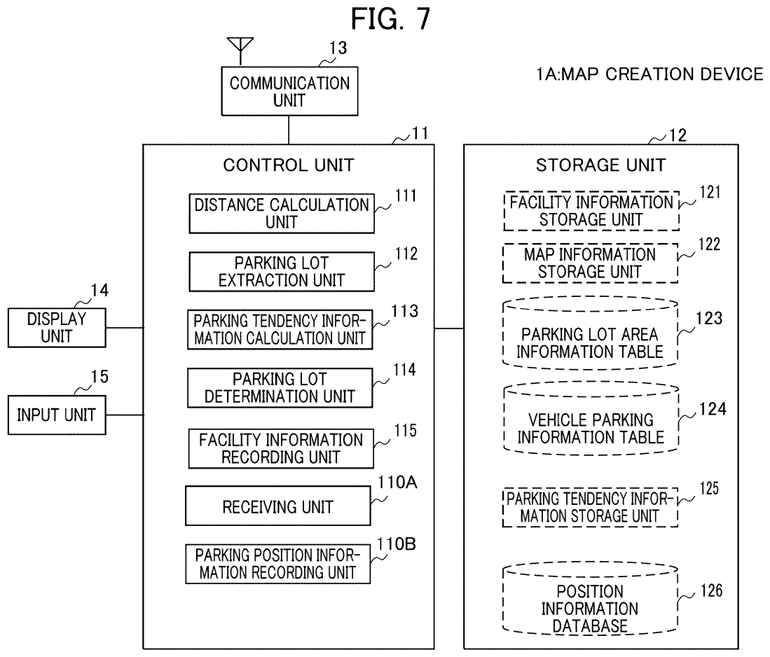

A functional block diagram relating to a modification of the map information creation device is illustrated in FIG. 7. In the embodiment explained above, the vehicle parking position information table 124 is configured to be downloaded as appropriate from the server device (not illustrated) connected to the communication network 60. However, as illustrated in FIG. 7, a map information creation device 1A may include, as functional blocks of the control unit 11, a receiving unit 110A and a parking position information recording unit 110B in addition to the distance calculation unit 111, the parking lot extraction unit 112, the parking tendency information calculation unit 113, the parking lot determination unit 114, and the facility information recording unit 115. The receiving unit 110A may receive identification information, position information, hour information, and the like of vehicles from the vehicles via the communication unit 13 and create and update, as appropriate, based on the identification information, the position information, the hour information, and the like received from the vehicles, the position information database 126 representing movement transition of the vehicles. The parking position information recording unit 110B may determine, based on the position information database 126, that a vehicle has parked when there is no change in the position information for a predetermined time or more and store the position information of the determination that the vehicle has been parked in the vehicle parking position information table 124 of the storage unit 12 as parking position information. Note that, as explained above, the vehicle ID can be prevented from being included in the vehicle parking position information table 124 from the viewpoint of personal information protection. The receiving unit 110A and the parking position information recording unit 110B are briefly explained below.

The receiving unit 110A receives continuous position information from a plurality of vehicles together with hour information. More specifically, the receiving unit 110A is a portion that updates the position information database 126 based on continuous position information and a vehicle ID (also referred to as mobile body ID) received from a vehicle (also referred to as mobile body).

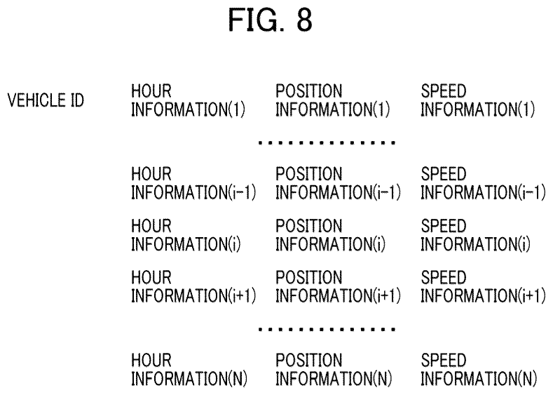

The position information database 126 may be configured to store, for example, position information of a traveling vehicle in at least recent one year. The position information database 126 may be configured to store position information of a traveling vehicle, for example, in prefecture units or region units. An example of a data structure of the position information database 126 is explained with reference to FIG. 8. As illustrated in FIG. 8, the position information database 126 may store “speed information” for each of vehicles in addition to the “vehicle ID” and the “continuous position information and hour information from the vehicle” received by the receiving unit 110A.

The “vehicle ID” in the position information database 126 is, as explained above, information for identifying an on-vehicle navigation device or a portable terminal, which is a transmission source of position information and the like and a vehicle mounted with the on-vehicle navigation device and the portable terminal. The “position information” in the position information database 126 is all pieces of continuous position information received from the vehicle from when transmission of position information and the like was started to the present. The “hour information” is hour information when positioning of the position information was performed. With all of these continuous position information and hour information, it is possible to specify vehicle parking information including a parking position and a parking date and time. Note that, when speed information is transmitted from the vehicle together with the position information, the received speed information is stored in linkage with the hour information and the position information.

When it is determined based on the position information database 126 that there is no change in vehicle position information for a predetermined time or more, the parking position information recording unit 110B determines that the vehicle has been parked. When determining that the vehicle has been parked, the parking position information recording unit 110B calculates a date and a day of week of the parking and a parking hour, a moving hour, and a parking time of the vehicle 50. The parking position information recording unit 110B stores position information where it is determined that the vehicle 50 has been parked as a parking position of the vehicle in the vehicle parking position information table 124. As explained above, the vehicle ID can be prevented from being included in the vehicle parking position information table 124 from the viewpoint of personal information protection. The parking position information recording unit 110B stores, in the vehicle parking position information table 124, parking position information and date and time information (a date and time and a day of week), a parking hour, a moving hour, a parking time, and the like at the parking position as well. Here, the parking hour indicates an hour when the mobile body has been parked at the parking position and the moving hour indicates an hour when the mobile body has been moved from the parking position. In the vehicle parking position information table 124, for example, a collection period may be set as one year and vehicle parking information may be recorded and accumulated in prefecture units or region units.

More specifically, for example, when, after transmission of position information and the like was once started, position information was received last and predetermined time position information has not been transmitted, the parking position information recording unit 110B may determine that a position corresponding to the position information received last is a parking position. In this case, the parking position information recording unit 110B may calculate, as the parking time of the vehicle, a predetermined time in which position information has not been transmitted. Besides, when a position corresponding to the transmitted position information does not change for a fixed time or more, the parking position information recording unit 110B may determine that the position is the parking position. In this case, the parking position information recording unit 110B may calculate, as a parking time of the vehicle, a time in which the position does not change. When an interval of respective hours when position information adjacent in continuous position information received from the vehicle was measured is longer or equal to or longer than a first time set in advance and shorter than or equal to or shorter than a second time set in advance and any one of pieces of speed information of the adjacent position information is lower than or equal to or lower than predetermined speed Vo set in advance, the parking position information recording unit 110B may determine that the vehicle has been parked. In this case, the parking position information recording unit 110B may calculate, as a parking time of the vehicle, an interval of respective hours when the adjacent position information was measured. Here, the predetermined speed Vo may be set to, for example, a degree of speed at the time when the vehicle is parked in a parking lot. The predetermined speed Vo may be set to 0 km/h. The predetermined speed Vo may be set according to characteristics of each vehicle (characteristics at a driving time of a driver). Accordingly, for example, even if a device is a device that cannot transmit position information at an ignition on time and/or an ignition off time, it can specify information expected as parking. Note that, when the vehicle stops the transmission of the position information of the vehicle according to ignition off, for example, like an on-vehicle navigation device in the current engine car, a current position transmitted immediately before the reception of the position information of the vehicle stopped may be set as the parking position. In this case, the parking position information recording unit 110B may calculate, as the parking time of the vehicle, a time from when the transmission of the position information of the vehicle stopped until the transmission of the position information of the vehicle is started next. Similarly, when the vehicle starts the transmission of the position information of the vehicle according to ignition on, for example, like the on-vehicle navigation device in the current engine car, a current position where the reception of the position information of the vehicle was started may be set as the parking position.

In this case, the parking position information recording unit 110B may calculate, as the parking time of the vehicle, an hour difference from an hour when the transmission of the position information of the vehicle was stopped before reception of the position information of the vehicle is started. Even when the vehicle is stopped like, for example, an electric car, when the vehicle can transmit stop signal information, the parking position information recording unit 110B may set, as the parking position, a current position indicated by a stop signal or most recent position information of position information of the vehicle. In this case, the parking position information recording unit 110B may calculate, as the parking time of the vehicle, a time from when the stop signal information was received until when start signal information or position information is received next. Similarly, when the vehicle can transmit the start signal information at the start time of the vehicle like, for example, an electric car, the parking position information recording unit 110B may set, as the parking position, a current position indicated by a start signal. In this case, the parking position information recording unit 110B may calculate, as the parking time of the vehicle, an hour difference from an hour when stop signal information was received or a position signal was received last before track signal information was received.

### Modification 2

In the embodiment explained above, it is explained that the map information creation device 1 is implemented by one server device or the like. However, a distributed processing system in which the functions of the map information creation device 1 are distributed to a plurality of server devices as appropriate may be adopted. The functions of the map information creation device 1 may be implemented using a virtual server function or the like on the cloud.

### EXPLANATION OF REFERENCE NUMERALS

1 map information creation device
1A map information creation device
11 control unit
110A receiving unit
110B parking position information recording unit
111 distance calculation unit
112 parking lot extraction unit
113 parking tendency information calculation unit
114 parking lot determination unit
115 facility information recording unit
12 storage unit
121 facility information storage unit
122 map information storage unit
123 parking lot area information table
124 vehicle parking position information table
125 parking tendency information storage unit
126 position information database
13 communication unit
14 display unit
15 input unit
60 communication network

1. A map information creation device comprising:
a map information storage that stores map information including center position information of a facility as facility information about a plurality of facilities and a plurality of pieces of parking lot polygon information;
a vehicle parking position information table including at least parking position information, date and time information of parking, and a parking time collected within a predetermined period, the parking position information being position information of a vehicle in a case in which there is no change in position information of the vehicle for a predetermined time or more;
a parking tendency information calculator that calculates parking tendency information of the parking lot polygon information with reference to the vehicle parking position information table;
a parking lot extractor that extracts the parking lot polygon information, a distance of which from a center position of one facility of the facility information is within a predetermined distance; and
a parking lot determiner that determines, when a plurality of pieces of the parking lot polygon information have been extracted by the parking lot extractor, based on parking tendency information of the plurality of pieces of parking lot polygon information extracted, the parking tendency information being calculated by the parking tendency information calculator, out of the plurality of pieces of parking lot polygon information extracted, the parking lot polygon information included in the parking lot of the facility.

2. The map information creation device according to claim 1, further comprising:
a receiver that receives continuous position information from a plurality of vehicles together with hour information; and
a parking position information recorder that determines that a vehicle has parked when there is no change in the position information for a predetermined time or more, and stores, in a storage, as a vehicle parking position information table, parking position information where the vehicle is determined as being parked.

3. The map information creation device according to claim 1, wherein
size information indicating a size of the facility is provided as the facility information,
the map information creation device further comprises a parking lot area information table representing a correspondence relation between an area serving as a size of the facility or a range of the area and a parking lot area of the facility standardly assumed according to the size of the facility or a range of the parking lot area, and
the parking lot determiner further
even when a plurality of pieces of the parking lot polygon information have been extracted by the parking lot extractor, when the size information of the facility is equal to or smaller than a size associated with an area obtained by totaling areas of the parking lot polygon information determined as being included in the parking lot of the facility, does not determine that the plurality of pieces of parking lot polygon information extracted as the parking lot polygon information are included in the parking lot of the facility.

4. The map information creation device according to claim 1, wherein
the parking tendency information calculator
plots, in the parking lot polygon, the parking position information included in the vehicle parking position information table, the parking position information being located in the parking lot polygon, and calculates the parking tendency information of the parking lot polygon information based on the plotted parking position information.

5. The map information creation device according to claim 4, wherein the parking tendency information of the parking lot polygon information includes at least any one of statistical values based on parking lot entering hours of vehicles parked in the parking lot in a predetermined period and statistical values based on staying times of the vehicles.

6. A map information creation method executed by a computer, comprising:
a map information storing step of storing map information including center position information of a facility as facility information for a plurality of facilities and a plurality of pieces of parking lot polygon information;
a step of storing a vehicle parking position information table including at least parking position information, date and time information of parking, and a parking time collected within a predetermined period, the parking position information being position information of a vehicle in a case in which there is no change in position information of the vehicle for a predetermined time or more;
a parking tendency information calculating step of calculating parking tendency information of the parking lot polygon information with reference to the vehicle parking position information table;
a parking lot extracting step of extracting the parking lot polygon information, a distance of which from a center position of one facility of the facility information is within a predetermined distance; and
a parking lot determining step of determining, when a plurality of pieces of the parking lot polygon information have been extracted in the parking lot extracting step, based on parking tendency information of the plurality of pieces of parking lot polygon information extracted, the parking tendency information being calculated by the parking tendency information calculating step, out of the plurality of pieces of parking lot polygon information extracted, the parking lot polygon information included in the parking lot of the facility.
